(19) United States
(12) Patent Application Publication
(10) Pub. No.: US 2011/0131052 A1
(43) Pub. Date: Jun. 2, 2011

(54) Method for Passively Determining Changes in Residency

(76) Inventor: Andrew Bucholz, Alexandria, VA (US)

(21) Appl. No.: 12/955,386

(22) Filed: Nov. 29, 2010

Related U.S. Application Data
(63) Continuation-in-part of application No. 11/965,166, filed on Dec. 27, 2007, now abandoned.
(60) Provisional application No. 60/882,023, filed on Dec. 27, 2006.

(51) Int. Cl. G06Q 99/00; G06Q 90/00

(52) U.S. Cl. 705/1.1; 705/500

(57) ABSTRACT

A system and method for determining residency based upon the comparison of existing data in various datasets. Information relating to a new utility account in a first jurisdiction is inputted. The inputted information is compared with stored account information from a second jurisdiction. If the inputted information matches the stored account information, the inputted information is compared to information relating to vehicle registrations in the second jurisdiction. If a matching vehicle registration is found in the second jurisdiction, the matching vehicle registration in the second jurisdiction is compared with vehicle registrations in the first jurisdiction. If no matching vehicle registration is found in the first jurisdiction, identifying a vehicle corresponding to the matching vehicle registration information in the second jurisdiction as an unregistered vehicle in the first jurisdiction. The steps may be repeated for third, fourth or many jurisdictions.

### CROSS-REFERENCE TO RELATED APPLICATIONS

The present application is a continuation-in-part of U.S. patent application Ser. No. 11/965,166 filed by the present inventor on Dec. 27, 2007 and which claims the benefit of the filing date of U.S. Provisional Patent Application Ser. No. 60/882,023, entitled “System and Method for Passively Determining Residency,” and filed on Dec. 27, 2006 by inventor Andrew Bucholz.

The foregoing applications are hereby incorporated by reference in their entirety.

### STATEMENT REGARDING FEDERALLY SPONSORED RESEARCH OR DEVELOPMENT

None.

### BACKGROUND OF THE INVENTION

1. Field of the Invention

The present invention relates to the field of determining residency of an individual in a particular jurisdiction, and more particularly, to determine whether the individual has failed to properly register a vehicle in a jurisdiction.

2. Brief Description of the Related Art

Jurisdictional entities in the United States use various methods for determining whether an individual is a resident of such jurisdiction. These residency determinations are very important because taxation of such individual and collection of various fees, such as automobile registrations, depend on residency. When a particular jurisdiction requires payment of a fee, such as for registering a vehicle, individuals often will avoid payment of such fee by maintaining their registration in the jurisdiction of their prior residence. Accordingly, there is a need for systems and methods to determine residency in an efficient and accurate manner.

### SUMMARY OF THE INVENTION

The present invention is a computer-implemented method for determining residency based upon comparisons of data in various databases or datasets. In a preferred embodiment, the present invention is a computer-implemented method for passively determining changes in residency and identifying unregistered or improperly registered vehicles. The method comprises the steps of inputting information relating to a new utility account in a first jurisdiction and storing such inputted information in an electronic storage means, and comparing the inputted information with stored account information from a second jurisdiction. The inputted information is then compared to stored information relating to vehicle registrations in the second jurisdiction if the inputted information matches the stored account information to identify matching vehicle registrations in the second jurisdiction. Any matching vehicle registration in the second jurisdiction is compared with vehicle registrations in the first jurisdiction. Vehicles corresponding to the matching vehicle registration in the second jurisdiction are identified as unregistered vehicles in the first jurisdiction if no matching vehicle registration is found in the first jurisdiction. The method may further comprise the repeating the steps for third, fourth or many jurisdictions.

In another embodiment, the present invention is a method for passively identifying unregistered vehicles comprising the steps of comparing first information of a first utility account in a first jurisdiction with second information of a second utility account in a second jurisdiction, if the first information matches the second information comparing the first information to vehicle registration information in the second jurisdiction to identify a vehicle registration in the second jurisdiction corresponding to the first information, if a corresponding vehicle registration is found in the second jurisdiction comparing the corresponding vehicle registration in the second jurisdiction with vehicle registrations in the first jurisdiction, and if no corresponding vehicle registration is found in the first jurisdiction identifying a vehicle associated with the corresponding vehicle registration information in the second jurisdiction as an unregistered vehicle in the first jurisdiction. The method may further comprise the repeating the steps for third, fourth or many jurisdictions.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a flow chart illustrating a preferred embodiment of a method of determining residency of an individual in a particular jurisdiction.

FIG. 2 is a flow chart illustrating a second preferred embodiment of a method of determining residency of an individual in a particular jurisdiction.

FIG. 3 is a continuation of the flow chart of FIG. 2 illustrating a preferred embodiment of a method of determining residency of an individual in a particular jurisdiction.

FIG. 4 is a continuation of the flow chart of FIG. 3 illustrating a preferred embodiment of a method of determining residency of an individual in a particular jurisdiction.

FIG. 5 is a flow chart illustrating a subroutine in connection with preferred embodiment of a method of determining residency of an individual in a particular jurisdiction.

### DETAILED DESCRIPTION OF THE PREFERRED EMBODIMENTS

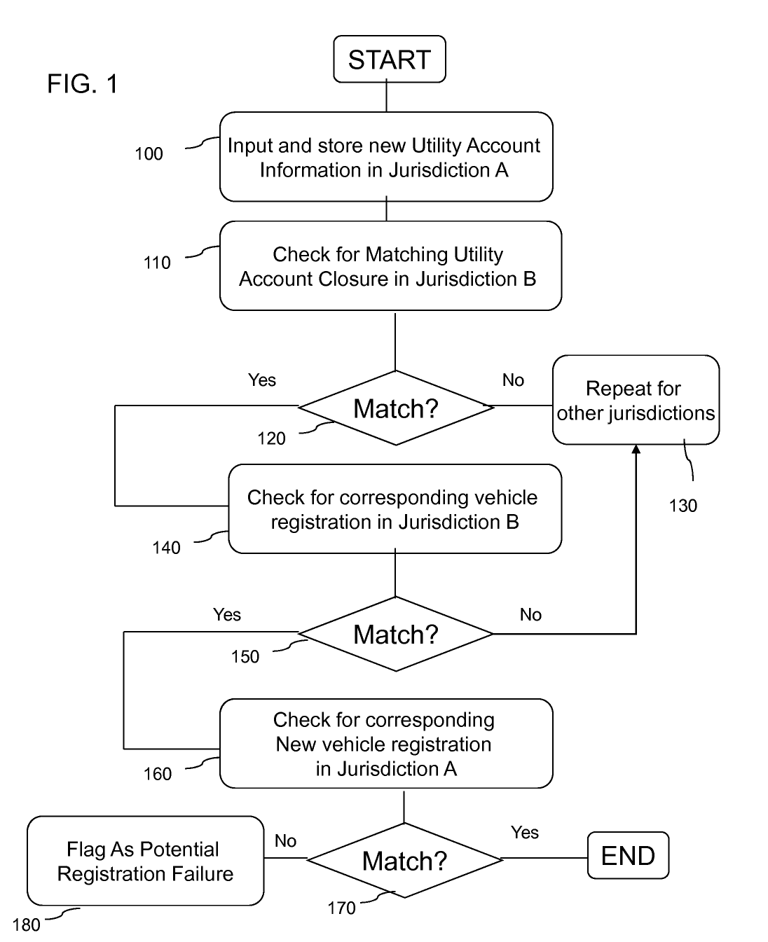

A method of a preferred embodiment of the present invention for comparing different datasets with one another to identify changes in residency and single out certain persons who fail to register, for example, their motor vehicle when relocating from one jurisdiction to another is described with reference to FIG. 1. For purposes of ease of description, the term “unregistered vehicle” is used herein to mean any vehicle that is not registered in the proper jurisdiction regardless of whether that vehicle is registered in other jurisdictions. The method of the preferred embodiment begins with a new account being opened 100 for service within the jurisdiction of a separate taxing authority. The new account may be any type of utility, including, but not limited to, the following: Telephone, Gas, Electric, Water, Property Records, Driver's License, Identification Card, Voter Record, Credit Card Billing, Bank Record, Passport Address, Vehicle Registration of a Second Vehicle, Government Identification, IRS Filings, Notification for Change of Address with Post Office. When the new service is employed, data regarding the new account is inputted into the system using any known means of inputting data and is stored in any electronic storage medium, and preferable is entered into a database. An electronic search 110 is performed by a processor or computer in a second database (or the same database if account information from multiple jurisdictions is stored in a single database) for matching account information of an account that has recently closed within a different taxing jurisdiction. If the system fails to find a matching account 120, the comparison is repeated 130 for any remaining unchecked jurisdictions contained within the dataset, which may be stored in one or more databases. If a matching closed account is found 120 in a separate taxing jurisdiction B, a search 140 is performed for a registered vehicle under the same information within jurisdiction B. If no match is found, the method returns to step 130. If a registered vehicle is found in jurisdiction B, a search for registration of the same vehicle will be performed for jurisdiction A 160. If no such registration is found 170, the account will be flagged and stored in a separate dataset 180 of Potential Registration Failures. This information can then be used by taxing jurisdiction A to contact said account holder to verify place of residence for the purpose of collecting vehicle registration money that may have otherwise gone uncollected. If a matching new registration is found in Jurisdiction A, the method will end with respect to that individual.

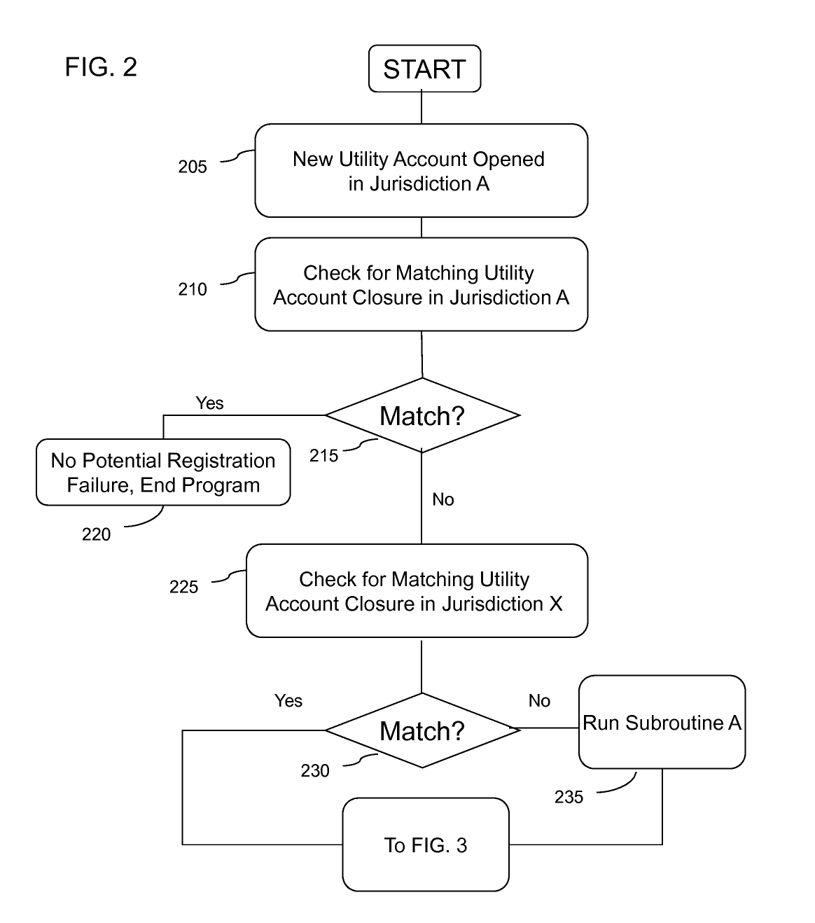

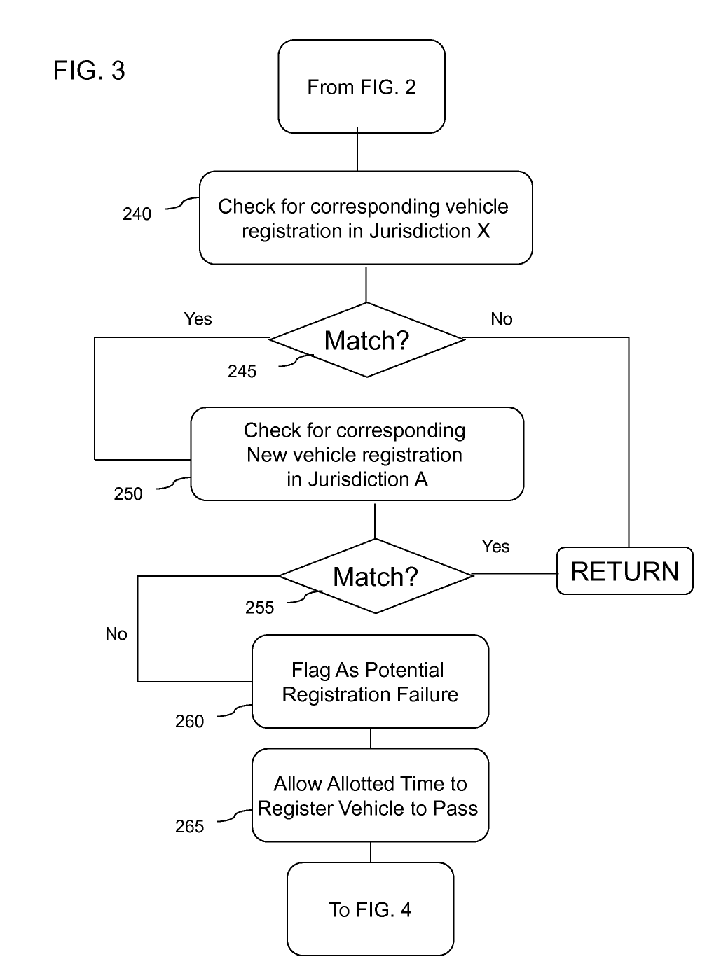

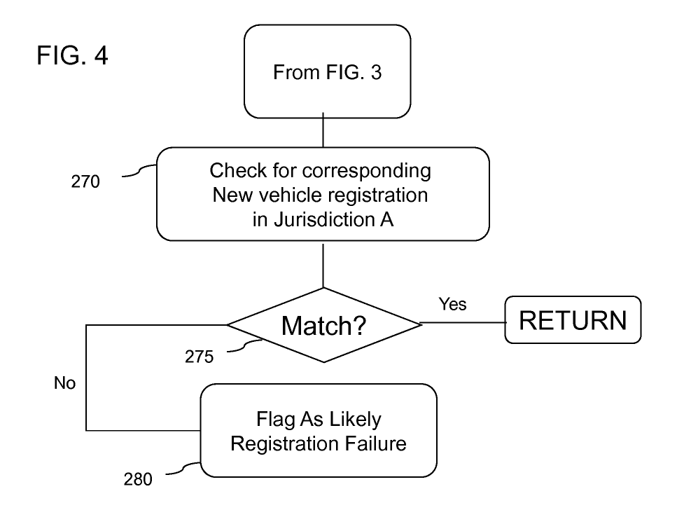

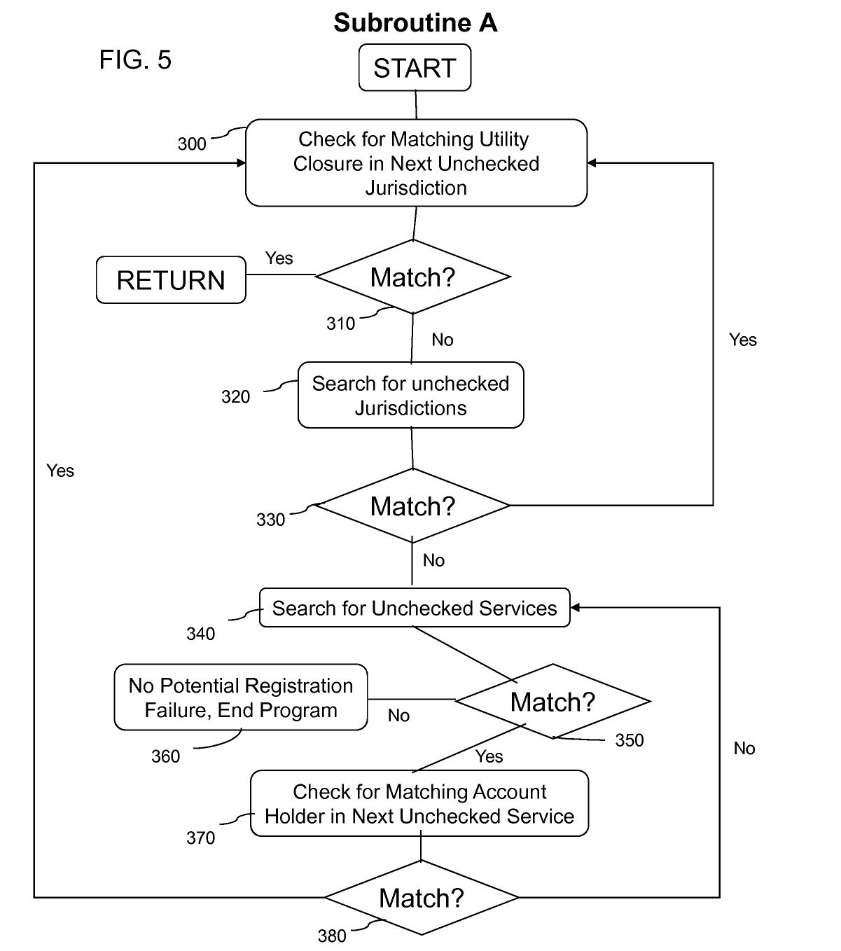

FIGS. 2-5 show a more complex method that is better equipped to catch any failure to register a motor vehicle. Step 205 will act the same as step 100 in FIG. 1 and step 210 will run a search for a matching account that has been closed within the same jurisdiction. If such an account is found at step 215, the method will end with respect to that new account 200. If no such account is found, step 225 will act the same as step 110 with jurisdiction X being a separate taxing authority. If step 230 fails to find a matching, closed account within jurisdiction X, it will run Subroutine A, shown in FIG. 5.

Subroutine A is designed to find the residence of an account holder when step 230 fails to find a match. Step 300 performs the same task as step 225. If step 310 finds a matching account in jurisdiction X, it returns to step 240. If no match is found, step 320 checks to see if there are any jurisdictions in the dataset that have not been searched for a match. If there are any left, step 330 returns the value of the unchecked jurisdiction to step 300. The process then repeats until all jurisdictions have been checked for a matching account. If no match is found in any of the jurisdictions in the dataset, step 340 will take the information on the account and send it through step 340 to see if any services have gone unchecked. If this check fails, step 350 will end the program with step 360 because there is no evidence that the account holder has moved from one jurisdiction to the next. If there are still unchecked services, step 370 will search for a matching account within a separate, unchecked service included in step 100. If a match is found, step 380 will cycle the information back to step 300 where it will undergo a search through each jurisdiction from steps 300 to 330 as described above. If no match is found, steps 340, 350 and 360 will continue to search each service until a match is found or every service has been checked. If every service has been checked and no match has been found, the search will fail at steps 350 and 360 will end the program.

If step 230 finds a matching, closed account within jurisdiction X, FIG. 2 will continue in the same way as FIG. 1. Step 240 will perform like step 140 and step 245 will perform like step 150. If there is a match, step 250 will perform like step 160. Like step 170, if there is no matching registration in the separate jurisdiction, the information will be sent to a dataset in step 260 which is the same as step 180. For any account stored in steps 260, 265 will allow the grace period to register a vehicle within a new jurisdiction to pass. At this point, step 270 will check again to see if the said vehicle has been registered within the jurisdiction A. Step 275 will compare the results and if no new registration is found, the account will be sent to a new dataset which will contain any accounts that have most likely moved to jurisdiction A but have failed to register their vehicle with the appropriate authorities.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

1. A computer-implemented method for passively identifying unregistered vehicles comprising the steps of:
inputting information relating to a new account associated with a person in a first jurisdiction, storing said inputted information in an electronic storage medium;
determining whether said person has changed residency by electronically comparing said inputted information with stored account information from a second jurisdiction, said second jurisdiction being different that said first jurisdiction;
if said inputted information matches said stored account information, comparing said inputted information to information relating to vehicle registrations in said second jurisdiction;
if a matching vehicle registration is found in said second jurisdiction, comparing said matching vehicle registration in said second jurisdiction with vehicle registrations in said new jurisdiction; and
if no match is found in said new jurisdiction, identifying said account as a potential registration failure and storing data relating to said account in a separate dataset in said electronic storage medium.

2. A computer-implemented method for passively identifying unregistered vehicles according to claim 1 further comprising the step of repeating said determining, comparing and identifying steps for a third jurisdiction if said inputted information does not match said stored account information from said second jurisdiction.

3. A computer-implemented method for passively identifying unregistered vehicles according to claim 1 wherein said new account comprises an account with a utility.

4. A computer-implemented method for passively identifying unregistered vehicles according to claim 1 wherein said new account comprises a new Driver's License.

5. A method for passively identifying unregistered vehicles comprising the steps of:
identifying a change in a jurisdiction of a person's residence by comparing inputted first information of a first utility account associated with said person in a first jurisdiction with stored second information of a second utility account in a second jurisdiction;
if said first information matches said second information, comparing said first information to vehicle registration information in said second jurisdiction to identify a vehicle registration in said second jurisdiction corresponding to said first information;
if a corresponding vehicle registration is found in said second jurisdiction, comparing said corresponding vehicle registration in said second jurisdiction with vehicle registrations in said first jurisdiction; and
if no corresponding vehicle registration is found in said first jurisdiction, identifying a vehicle associated with said corresponding vehicle registration information in said second jurisdiction as an unregistered vehicle in said first jurisdiction.

6. A method for passively identifying unregistered vehicles according to claim 5 further comprising the step of issuing a citation to an individual listed as an owner of said unregistered vehicle.

7. A method for passively identifying unregistered vehicles comprising the steps of:
determining whether a person has moved their residence to a new jurisdiction by inputting information relating to a new account associated with said person in said new jurisdiction, storing said inputted information in an electronic storage medium and comparing said inputted information with stored account information from a plurality of other jurisdictions;
if said inputted information matches stored account information from a second jurisdiction, comparing said inputted information to information relating to vehicle registrations in said second jurisdiction;
if a matching vehicle registration is found in said second jurisdiction, comparing said matching vehicle registration in said second jurisdiction with vehicle registrations in said new jurisdiction; and
if no match is found in said new jurisdiction, identifying said account as a potential registration failure and storing data relating to said account in a separate dataset in said electronic storage medium.
